(19) United States
(12) Patent Application Publication
(10) Pub. No.: US 2026/0298038 A1
(43) Pub. Date: Oct. 1, 2026

(54) BACKUP WRENCH FOR POWER TONG

(71) Applicant: Metalmecanica S.A., Buenos Aires (AR)

(72) Inventors: Raul Julio Federico Camara Guillet, Buenos Aires (AR); Edgardo Oscar Lopez, Buenos Aires (AR)

(21) Appl. No.: 19/480,685

(22) PCT Filed: May 3, 2024
(86) PCT No.: PCT/EP2024/062264

§ 371 Date: Oct. 31, 2025

(30) Foreign Application Priority Data
May 3, 2023 (NL) 2034753

(51) Int. Cl. E21B 19/16

(52) U.S. Cl. CPC E21B 19/167; E21B 19/166

(57) ABSTRACT

Backup wrench for a power tong. The backup wrench comprises measuring means for measuring torque.

The present invention relates to a backup wrench for a power tong, a backup wrench assembly for a power tong, a method of assembling a backup wrench assembly, and the use of a backup wrench assembly.

In mature oil fields, it may be necessary to promote the production of a hydrocarbon well. A common way of promoting this production is to introduce to the well a positive displacement pump, such as a reciprocating pump, downhole that is connected to driving means, such as a pump jack, at the surface level of the well. The reciprocating pump is connected to the driving means via a string of sucker rods.

The string is formed by a multitude of sucker rods that are connected to each other by means of threaded connections. The threaded connections comprise a first threaded connection member that is provided at a first longitudinal end of a sucker rod, and a second threaded connection member that is provided at a second longitudinal end of another sucker rod. In some cases, the first threaded connection member has a first thread on its outer circumferential surface, and the second threaded connection member has a second thread on its inner circumferential surface, wherein the first and second threads correspond to facilitate rotational engagement with each other. In other cases, the threaded connection further comprises a coupling with at a first longitudinal coupling end a first threaded coupling member with a first coupling thread, and at a second longitudinal coupling end opposite to the first longitudinal coupling end a second threaded coupling member with a second coupling thread. In this case, the first threaded connection member has a first thread that corresponds with the first coupling thread to facilitate rotational engagement, and the second threaded connection member has a second thread that corresponds with the second coupling thread to facilitate rotational engagement. The first and second coupling thread may be provided on the inner circumferential surface of the first and second threaded coupling members of the coupling, wherein the first and second thread of the first and second threaded connection members are provided on the outer circumferential surface of the first and second threaded connection members.

To connect (or make-up) the sucker rods with each other, a power tong in combination with a backup wrench may be used. A first sucker rod is lowered into the well and held in place with the first threaded connection member pointing upwards, wherein rotational movement of this lower sucker rod is prevented by means of the backup wrench. A second sucker rod is positioned above the lower sucker rod with the second threaded connection member pointing downwards, wherein this upper sucker rod is held in place with a jaw of the power tong. A coupling may be provided on either of the lower and upper sucker rods. The sucker rods are then brought towards each other, wherein the jaw of the power tong is actuated to rotate the upper sucker rod with respect to the lower sucker rod wherein a threaded connection between the sucker rods is formed.

When making up the sucker rods, it is important that the correct amount of torque is applied. Too much torque may yield the threads, causing permanent deformations at the threads, whereas too little torque might result in inadvertent disengagement of the sucker rods during operation.

To determine whether the sucker rods have been made up correctly, the sucker rods and/or coupling may have on the outer circumferential surface thereof a make-up mark. The marks are used to obtain an indication about whether or not the sucker rods have been made up correctly. For example, if the mark of the lower sucker rod is within a certain allowable distance from the mark of the upper sucker rod, the sucker rods have been made up correctly.

This way of determining whether the sucker rods have been made up correctly is, however, inefficient. In particular, dedicated measuring tools are required that are fitted to the specifications (e.g. diameter, allowable deviation between the marks, etc.) of the sucker rods, and the act of measuring takes up time that could have been spent differently. Moreover, the accuracy of the resulting measurements may differ from operator to operator.

To meet demands of the high-end market, more sophisticated power tongs are available. These sophisticated power tongs are outfitted with measuring equipment to measure the amount of torque applied by the power tong.

Although these power tongs take away the need to measure manually, they generally come with many features and functionalities to meet higher market demands. As such, these power tongs tend to be relatively expensive, and less abundantly available. Moreover, these power tongs tend to have a complex structure with many interconnected parts. As such, it can be difficult to replace broken or worn parts, wherein a considerable amount of skill is needed to do so.

This complexity becomes in particular relevant in cases where the measuring equipment has to be serviced and/or does not function properly and the hydrocarbon well is located at a difficult to reach location.

It is an object of the present invention to provide an improved, or at least alternative solution with respect to the prior art. In particular, it is an object of the present invention to provide a solution, wherein operating a power tong is more efficient and less complex.

The object is achieved in a first aspect in accordance with the present invention with a backup wrench for a power tong, the backup wrench comprising measuring means for measuring torque.

The present invention provides an easy to use modular solution to the problems of the prior art. As the measuring means is located on the backup wrench, all torque measuring equipment can be provided to the power tong by assembling the backup wrench with the power tong, and taken away from the power tong by removing the backup wrench from the power tong, respectively. This way, it is possible to enable existing power tongs to conduct torque measurements. In addition, installation and/or replacement of the measuring means can be performed with few structural adjustments to the power tong. Accordingly, the present invention is more efficient and less complex.

Moreover, the backup wrench in accordance with the present invention is pre-assembled with the measuring means. In the event that the measuring means does not function properly, the operator has a strong indication that something is wrong with the backup wrench. The backup wrench can then simply be replaced, wherein downtime at the well is limited.

Even further, the present invention enables efficient logistics. To meet certain quality standards, it may be required to have a power tong, including the torque measuring equipment, (re) certified. With the present invention, it is possible to have the backup wrench with the measuring means certified apart from a power tong. As such, (re) certification of the measuring means can be done with fewer parts. Accordingly, the invention allows to have less demanding, and cheaper logistics when (re) certification of the measuring means of a power tong is required.

The measuring means as described in the present disclosure comprises a measuring element. The measuring element may comprise an analogue sensor, or a digital sensor.

In particular, the measuring means is adapted to measure torque applied by a power tong to a sucker rod by measuring torque received, via the sucker rods, at the backup wrench. In particular, the torque is measured during the make-up process.

To this end, the measuring element may be configured for measuring a torque indicator. The torque indicator may relate, for instance, to a material deformation, or a pressure change. Preferably, the measuring means, in particular the measuring element, converts the torque indicator into an electrical output signal. The electrical output signal may change in proportion to the measured torque indicator. More in particular, the measuring element may comprise a Wheatstone bridge, wherein the electrical output signal is an electric pressure.

Embodiments in accordance with the first, a second, a third, and a fourth aspect of the present invention are described in the following.

In an embodiment of the first aspect of the present invention, the backup wrench further comprises a mounting member for mounting the backup wrench to a backup wrench mount of a power tong. Preferably, the measuring means, in particular the measuring element of the measuring means, is located away from the mounting member. In other words, the measuring means is preferably located at a distance from the mounting member. The mounting member can comprise a mounting element having a mounting hole for receiving a corresponding mounting element, such as a pin, or a bolt. In particular, the mounting hole is a through hole. The backup wrench mount of the power tong can comprise another mounting element with a mounting hole such to allow a mechanical connection of the mounting member with the backup wrench mount via the corresponding mounting element.

The mounting hole extends along a mounting hole axis, which mounting hole axis preferably extends in a torque application direction. In particular, the mounting hole axis may extend tangential to the rotational torque received at the backup wrench. This way, rotation of the backup wrench about the mounting member may be prevented.

An advantage of the above embodiments is that the measuring means can function independently from the mounting member. This allows design freedom with respect to the mounting member. In particular, the mounting member can be customized to comply with the design requirements of various power tongs (that are already in use). Hence, the backup wrench design may be even more efficient.

In an embodiment in accordance with the first aspect of the present invention, the backup wrench comprises a wrench head for engaging a sucker rod. Preferably, the measuring means, in particular the measuring element, is located away from the wrench head. In other words, the measuring means is located at a distance from the wrench head.

An advantage of the above embodiment is that the wrench head can engage a sucker rod free from adjustment of the measuring means. In particular, the backup wrench can be adapted to fit with various rod sizes, without having to change the design the measuring means.

In an embodiment in accordance with the first aspect of the present invention, the measuring means, in particular the measuring element, is located between the mounting member and the wrench head. In particular, the backup wrench extends along a (first) longitudinal axis, wherein the wrench head is provided at a first longitudinal end, and the mounting member is provided at a second longitudinal end opposite the first longitudinal end.

In an embodiment in accordance with the first aspect of the present invention, the backup wrench comprises a wrench body. The wrench body is located between the mounting member and the wrench head. In particular, the measuring means is located at the wrench body. More in particular, the measuring element of the measuring means is located at, even more in particular on, the wrench body.

The above embodiments regarding the location of the measuring means and the measuring element, are preferred embodiments, in particular, because torque may be accurately measured. In particular, the torque indicator can be measured at a distance from the wrench head where the torque indicator is more evident. Also, in line with above described embodiments, other parts of the backup wrench can be adapted free from adjustment of the measuring means. That said, it is envisioned that, alternatively, the measuring means may be located at a different location, such as at the wrench head.

In an embodiment in accordance with the first aspect of the present invention, the mounting member, the wrench head, and the wrench body, are integrally formed. In particular, the mounting member is integrally formed with the wrench body, and the wrench body is integrally formed with the wrench head. This means that the wrench body, the mounting member, and the wrench head, are together formed of a single piece of material. In particular, the material is cast iron.

An advantage of an integrally formed backup wrench is that the backup wrench may be less susceptible to damage. As such, the backup wrench is less likely to be damaged, wherein it is less likely that the backup wrench needs to be replaced. In particular, the backup wrench is adapted to sustain a torque of 100 to 2500 pound-foot (lb-ft).

In an embodiment in accordance with the first aspect of the present invention, the wrench body comprises a wrench body slot, wherein the measuring element is arranged in the wrench body slot. The wrench body slot can be a blind slot. The backup wrench may comprise a cover for covering the measuring element.

In embodiments comprising a wrench body slot, torque may be measured more accurately, in particular because reaction forces as a result of torque received at the backup wrench may be transferred through a relatively small cross sectional area. The cover may protect the measuring element.

In an embodiment in accordance with the first aspect of the present invention, the backup wrench comprises a stop shoulder. In particular, the stop shoulder adjoins the wrench body. In embodiments with a stop shoulder, the measuring element is preferably located next to (or adjacent) the stop shoulder. In particular, the measuring element and the stop shoulder are located in longitudinal direction along the longitudinal axis at about the same height. Differently put, the measuring element can be located at a measuring element distance from the wrench head, and the stop shoulder can be located at a stop shoulder distance from the wrench head, wherein the measuring element distance and the stop shoulder distance are (approximately) the same.

In an embodiment in accordance with the first aspect of the present invention, the wrench head comprises a wrench head jaw for engaging a non-circular portion of a sucker rod. The non-circular portion of the sucker rod may comprise the wrench flats of the sucker rod. In particular, the wrench head jaw may comprise a wrench head jaw profile having two (parallel) inner jaw surfaces. The inner jaw surfaces may define a wrench head jaw opening for receiving the non-circular portion of the sucker rod, wherein, after receiving the non-circular portion, rotational movement of the sucker rod with respect to the backup wrench is limited. In particular, the inner jaw surfaces may contact the wrench flats when the sucker rod is engaged by the wrench head. As such, the backup wrench is adapted to engage a sucker rod. An advantage of this embodiment is that the wrench head can engage a sucker rod laterally.

In an embodiment in accordance with the first aspect of the present invention, the measuring means further comprises a communication unit. The communication unit is adapted for communicating measurements (e.g. the electrical output signal) of the measuring means, in particular, to a processing unit. The communication unit can be configured for wired communication, in particular with the processing unit. In such case, the communication unit may comprise a socket for receiving a communication line (or cable).

The communication unit may be provided in a wrench body hole in the wrench body. In particular, the wrench body hole is a through hole. The wrench body hole may be provided in the wrench body slot. In a preferred embodiment, the wrench body hole extends along a wrench body hole axis, wherein the wrench body hole axis extends transverse with respect to the longitudinal axis of the backup wrench. The wrench body hole axis may further extend parallel to a torque application axis.

An advantage of embodiments employing a wrench body hole is, that torque may be measured more accurately.

Alternatively, the communication unit may be configured for wireless communication, in particular with a processing unit. In such case, the communication unit comprises a transmitter for transmitting wireless communications (e.g. via Bluetooth or a cellular network), and the measuring means comprises a power source (e.g. a battery and/or an energy generator) connected to the transmitter of the communication unit. In such embodiment, the power source may further be connected to the measuring element and/or the processing unit.

An advantage of embodiments employing measuring means with a communication unit is that measurement data (e.g. a measured torque indicator) may be processed at a processing unit that is arranged away from the backup wrench.

Presently, embodiments employing a communication unit configured for wired communication are preferred. In such embodiments, the communication unit can comprise a receiver, e.g. a socket, for receiving and holding a communication line or cable. The communication line can, for instance, comprise electrically conductive material or glass fibre. Embodiments having a communication unit configured for wired communication with a processing unit allow for the processing of measurement data, wherein the power source for providing power to the measuring means, and/or processing unit is located at a distance from the hydrocarbon well. Apart from the fact that the construction of the measuring means of the backup wrench remains relatively simple, a safer environment at the hydrocarbon well can be provided. In particular, the backup wrench can be free from a battery that could cause a fire hazard at the hydrocarbon well.

In an embodiment in accordance with the first aspect of the present invention, the measuring means comprises a strain gauge, or an array of strain gauges. The strain gauge(s) may comprise a grid with a strain sensitive grid length direction, and a strain insensitive grid width direction. Preferably, the strain sensitive grid length direction is aligned with the torque application direction. The strain gauge may be located in the wrench body slot. In particular, the strain gauge is arranged adjacent the circumference of the wrench body hole. Preferably, the strain gauge comprises a Wheatstone bridge, comprising an electric input, and an electric output, wherein, during operation, a torque indicator may be taken based on a difference in electrical pressure between input and output.

In accordance with a second aspect of the present invention there is provided a backup wrench assembly for a power tong. In particular, the assembly is arranged to measure the torque applied by a power tong to a sucker rod. The assembly in accordance with the second aspect comprises a backup wrench, which backup wrench includes measuring means for measuring the torque.

In an embodiment in accordance with the second aspect of the present invention, the backup wrench assembly comprises:
a backup wrench including a wrench head; and
at least one (e.g. a first) insert, the at least one (e.g. a first) insert being (releasably) mountable to the wrench head and adapted for engaging the non-circular portion of a sucker rod of a first size;
   wherein the wrench head is adapted for engaging the non-circular portion of a sucker rod of a size different from the first size (e.g. a third size). In particular, the third size is greater than the first size.

In an embodiment in accordance with the second aspect of the present invention, the backup wrench assembly comprises:
a backup wrench including a wrench head; and
at least two (e.g. a first and a second) insert(s), the at least two inserts being (releasably) mountable to the wrench head and adapted for engaging the non-circular portion of a sucker rod, wherein:
a first insert of the at least two inserts is configured for engaging the non-circular portion of a sucker rod of a first size, and
a second insert of the at least two inserts is configured for engaging the non-circular portion of a sucker rod of a second size, wherein the first size is different from the second size.

From the above it should be understood, that the assembly may have a backup wrench with a wrench head for engaging the non-circular portion of a sucker rod of a particular size, and at least one insert, wherein the at least one insert is adapted (or configured) for engaging the non-circular portion of a sucker rod of a different size. Alternatively, the assembly may have a backup wrench with a wrench head, and at least two inserts, wherein the inserts are adapted for engaging the non-circular portion of sucker rods of different sizes. As in both situations, the inserts are mountable to the wrench head, in particular in the wrench head, one could say that in both situations the wrench head is configured for engaging the non-circular portion of a sucker rod, albeit indirectly via an insert, and/or directly (without an insert). In particular, it is noted that the backup wrench assembly may comprise a multitude of inserts, wherein each insert is configured to engage a sucker rod of a particular size.

Each insert may comprise an insert jaw for engaging a non-circular portion, in particular the wrench flats, of a sucker rod. The insert jaw may have an insert jaw opening for receiving the non-circular portion of a sucker rod. In particular, a first insert may have a first insert jaw having a first insert jaw opening, and a second insert may have a second insert jaw having a second insert jaw opening, wherein the first insert jaw opening is greater than the second insert jaw opening.

The wrench head may comprise a wrench head jaw for engaging a non-circular portion, in particular the wrench flats, of a sucker rod. The wrench head jaw may have a wrench head jaw opening for receiving the non-circular portion of a sucker rod. The wrench head jaw opening may be greater than the insert jaw opening of an insert.

The opening of the insert jaw may be defined by at least two (parallel) inner insert jaw surfaces, wherein the inner insert jaw surfaces are located at a distance from each other. In particular, the inner insert jaw surfaces provide an opening with an opening size for receiving the non-circular portion of a sucker rod of a size corresponding with the opening size. In particular, the inner insert jaw surfaces may be in contact with the wrench flats of the sucker rod when the sucker rod is engaged by the insert jaw. Similarly, the opening of the wrench head jaw may be defined by at least two (parallel) inner wrench head jaw surfaces, wherein the inner wrench head jaw surfaces are located at a distance from each other. In particular, the inner wrench head jaw surfaces provide an opening with an opening size for receiving the non-circular portion of a sucker rod of a size corresponding with the opening size. In particular, the inner wrench head jaw surfaces may be in contact with the wrench flats of the sucker rod when the sucker rod is engaged by the wrench head jaw.

It should be appreciated, that neither the inner insert jaw surfaces, nor the inner wrench head jaw surfaces, are necessarily parallel. The surfaces could be non-parallel with respect to each other. It is merely important that the surfaces are adapted to engage the non-circular portion of a sucker rod, wherein during engagement rotational movement of the sucker rod is limited by the backup wrench. For example, the inner insert jaw surface and/or the inner wrench head jaw surfaces could be aligned with a portion of a sucker rod having a triangular shaped cross section.

Preferably, the inserts are mountable to the wrench head by means of an insert mounting element, such as a screw, or a bolt, which insert mounting element is received in a screw hole, or bolt hole, in the backup wrench. In particular, the inserts are insertable in the wrench head. Alternatively, the mountable insert can be shape fittingly held in the wrench head, free from an insert mounting element. In such case, the insert may have at least one extension part limiting movement of the insert with respect to the backup wrench in a direction transverse to the longitudinal axis of the backup wrench, wherein the insert is, in use, further limited in the longitudinal direction along the longitudinal axis by a by the wrench head engaged sucker rod.

An advantage of embodiments employing inserts is, that efficiency can be further increased, and that complexity can be further reduced. In particular, a single backup wrench can be used for various sucker rod sizes, wherein an operator can easily select an insert (or no insert) to make the backup wrench suitable for a particular sucker rod size. As such, embodiments employing inserts allow for a simple modular solution with efficient handling. In addition, it should be appreciated that a backup wrench comprising measuring means may be relatively expensive as compared to a conventional backup wrench. By providing a backup wrench assembly with one or more inserts, one may require fewer wrenches, and fewer certifications. The present invention may thus provide a cost efficient and easy to use solution for a wrench including measuring means.

In an embodiment in accordance with the second aspect of the present invention, the backup wrench of the backup wrench assembly includes a mounting member. The mounting member may be configured for mounting the backup wrench to a backup wrench mount of a power tong. The backup wrench assembly further comprises at least one mounting adapter, the at least one mounting adapter being (releasably) mountable to the mounting member and having a power tong mount for mounting the mounting adapter to a backup wrench mount of a power tong, wherein the mounting member is different from the power tong mount. The mounting member may be adapted for mounting the backup wrench to a third backup wrench mount of a third power tong, and the at least one mounting adapter is adapted for mounting the mounting adapter to a first backup wrench mount of first power tong, wherein the first backup wrench mount is different from the third backup wrench mount.

In an embodiment in accordance with the second aspect of the present invention, the backup wrench assembly comprises:
a first mounting adapter having a first power tong mount, and
a second mounting adapter having a second power tong mount,
   wherein the first power tong mount is different from the second power tong mount. In particular, the first power tong mount is configured for mounting the first mounting adapter to a first backup wrench mount of a first power tong, and the second power tong mount is configured for mounting the second mounting adapter to a second backup wrench mount of a second power tong, wherein the first backup wrench mount is different from the second backup wrench mount.

In particular, the first power tong mount is mountable to a first backup wrench mount of a first power tong, and the second power tong mount is mountable to a second backup wrench mount of a second power tong. Preferably, each mounting adapter comprises a power tong mount that is different from the power tong mount of another mounting adapter. More preferably, each mounting adapter comprises a wrench mounting element for mounting the mounting adapter to the backup wrench, wherein the wrench mounting element of each mounting adapter is identical.

In some embodiments, the backup wrench can be mounted to the backup wrench mount of a power tong directly by means of the mounting member, and indirectly via one of the mounting adapters. In other embodiments, the backup wrench can be mounted to the backup wrench mount of a power tong indirectly via one of the mounting adapters.

An advantage of embodiments employing one or more mounting adapters is, that one can easily adapt the backup wrench to fit with various power tongs, in particular to fit with a set of power tongs that are frequently used.

In an embodiment in accordance with the second aspect of the present invention, the backup wrench includes a wrench body, wherein the measuring means, in particular the measuring element, is located at the wrench body. In particular, the wrench body adjoins the wrench head and/or the mounting member. More in particular, the wrench body is located between the wrench head and the mounting member.

In an embodiment in accordance with the second aspect of the present invention, the wrench head defines a rotation axis position for a sucker rod. This rotation axis position is a position along the longitudinal axis of the backup wrench at which the sucker rod, in particular the central rotation axis of the sucker rod, is positioned when engaged by the backup wrench.

In an embodiment in accordance with the second aspect of the present invention, the first insert is dimensioned to receive a first sucker rod of a first size with its (central) rotation axis at the rotation axis position. The second insert is dimensioned to receive a second sucker rod of a second size with its (central) rotation axis at the rotation axis position, and/or the wrench head is dimensioned to receive a third sucker rod of a third size with its (central) rotation axis at the rotation axis position.

In an embodiment in accordance with the second aspect of the present invention, each insert comprises:
an insert opening having an insert opening size for receiving a sucker rod, and
a positioning part for positioning the sucker rod received in the insert opening,
   wherein each insert complies with:

$$A = T - \frac{1}{2} B , \qquad ( 1 )$$

wherein A is the longitudinal extent of the positioning part, B is the insert opening size, and T is the longitudinal distance from and including the positioning part up to the rotation axis position.

It should be appreciated, that the above equation (1) takes into account sucker rods with a non-circular portion whereat the sucker rod has a square-shaped cross section. If the cross section of a sucker rod at the non-circular portion location is non-square (e.g. rectangular) the insert may comply with:

$$A = T - \frac{1}{2} B + x , \qquad ( 2 )$$

wherein x is a correction factor depending on the cross sectional shape of the sucker rod at the non-circular portion. The distance x is measured in a cross sectional plane and in a direction perpendicular to the central longitudinal sucker rod axis. Distance x may be retrieved from a database comprising specific sucker rod specifications.

In certain embodiments the wrench head comprises a wrench head jaw with a wrench head jaw opening having a wrench head jaw opening size, wherein the wrench head is adapted to engage a sucker rod of a third size. The sucker rod of the third size is, when engaged by the wrench head, located with its rotation axis at the rotation axis position.

The wrench head jaw opening size may be measured in a plane perpendicular to the longitudinal axis of the wrench head. The wrench head jaw opening size may be a smallest distance between the inner wrench head jaw surfaces.

As the wrench head defines the rotation axis position, the rotation axis position depends on the dimensions of the backup wrench, wherein the rotation axis position is at a fixed longitudinal distance from the measuring means, in particular from the measuring element. The wrench head does not require a positioning part. As such, one could say that in the case that the wrench head comprises a wrench head jaw opening for receiving a sucker rod of a particular size, the distance A of the wrench head is zero.

In particular, the wrench head may comprise an axial contact surface for contacting a positioning part surface of an insert. In such case, the axial contact surface contacts the positioning part surface of an insert mounted to the wrench head.

Each insert may comprise a positioning part. The positioning part may be dimensioned in dependency of the insert opening size and the by the wrench head defined location of the rotation axis position. By dimensioning the positioning part of each insert, it is possible to ensure that the rotation axis of each sucker rod is positioned at (about) the same location with respect to the measuring means. This way, the measuring means may measure torque accurately.

In an embodiment in accordance with the second aspect of the present invention, each insert has a longitudinal insert axis. In particular, the longitudinal insert axis is parallel to the longitudinal axis of the backup wrench. The insert opening size may be measured in a plane perpendicular to the longitudinal insert axis. The opening size may be a smallest distance between the inner insert jaw surfaces.

In an embodiment in accordance with the second aspect of the present invention, the backup wrench assembly comprises:
a processing unit for processing measurement data (e.g. an electrical output signal) of the measuring means; and
a communication means, wherein the communication means is suitable for (communicatively) connecting the measuring means to the processing unit.

The communication means is configured for communicatively connecting the measuring means, in particular the communication unit of the measuring means, to the processing unit. As explained above, preferably the communication means comprises a communication cable.

The (first) processing unit may be arranged at user equipment (e.g. a laptop, a tablet, or a portable torque reader). The processing unit is configured for processing measurement data of the measuring means. In particular, the processing unit is arranged for determining a torque value based on measurement data, in particular an electrical output signal, from the measuring means, in particular from the measuring element. The processing unit may determine a torque value based on a difference between an electrical input signal sent to the measuring element and an electrical output signal received from the measuring element. The processing unit calculate the torque value based on an algorithm. The algorithm may comprise a longitudinal distance variable relating to the longitudinal distance between the measuring element and the wrench head.

The processing unit may be connected to a database. The database contains information about specific sucker rods. For example, the database may contain information about the amount of torque required to make up a sucker rod connection. In particular, the database may contain threshold (maximum and/or minimum) torque values per specific sucker rod. In addition, it is anticipated that the longitudinal distance between the measuring element of a backup wrench and the position of the rotation axis of a sucker rod engaged by the backup wrench may vary depending on the size of the sucker rod. For example, the rotation axis of a sucker rod with a smaller diameter may be located closer to the measuring element than the rotation axis of a sucker rod with a larger diameter. The database may contain longitudinal distance values for various specific sucker rods. The processing unit may calculate the torque value based on an algorithm including the specific longitudinal distance value.

Preferably, the user equipment comprises a screen, wherein the processing unit is arranged for presenting a torque value on the screen.

In certain embodiments, the backup wrench assembly comprises a storage unit. The storage unit may be comprised by the user equipment. The storage unit is adapted to store torque values from the processing unit over time. The processing unit may be arranged to plot a graph on the screen showing torque values over time, wherein the lower and upper bound of threshold torque values for a specific sucker rod are included.

In certain embodiments, the user equipment is connected to a user system (e.g. in a control room) located at a distance from the hydrocarbon well, wherein the user equipment is arranged for transmitting processed measurement data, in particular torque values, to the user system. In such case, it is preferred that the first processing unit is configured for processing the measurement data, wherein the user system comprises a second processing unit, and the database. The storage unit is preferably arranged at the user equipment. The user system may comprise one or more user system screens. In this embodiment, the torque values over time are plotted on the user system screen(s), wherein the second processing unit compares the threshold values with the torque values received from the measuring means, wherein the second processing unit issues an alarm signal when a torque value is higher than an upper threshold value, and lower than a lower threshold value.

In an embodiment in accordance with the second aspect of the present invention, the assembly comprises a control unit, in particular for controlling the torque applied by a power tong, based on a torque value from the processing unit. In a preferred embodiment, the control unit is arranged to adapt, or instruct to adapt, the torque applied by a power tong based on a signal from the processing unit. In particular, the processing unit may be arranged to send a signal to the control unit when a torque value determined by the processing unit falls outside the threshold range defined between the upper bound and the lower bound, wherein the control unit is configured for adjusting the applied torque.

In an embodiment in accordance with the second aspect of the present invention, the assembly comprises a backup wrench in accordance with any embodiment described in relation to the first aspect.

In accordance with a third aspect of the present invention there is provided a method of assembling a backup wrench assembly with a power tong, comprising the step of:
mounting a backup wrench to a power tong, wherein the backup wrench comprises measuring means for measuring torque.

In an embodiment in accordance with the third aspect of the present invention, the method further comprises the steps of:
providing at least one mounting adapter, in particular a plurality of mounting adapters; and
mounting, in particular at a hydrocarbon well, the mounting adapter to a backup wrench mount of a power tong, and the mounting member of the backup wrench to the mounting adapter.

The step of providing at least one mounting adapter may entail providing a first mounting adapter and a second mounting adapter. A third, fourth, fifth, etc. mounting adapter may also be provided.

In an embodiment in accordance with the third aspect of the present invention, the method further comprises the steps of:
selecting, in dependency of a configuration of the backup wrench mount of the power tong, a most suitable mounting adapter out of the provided mounting adapters; and
mounting the selected mounting adapter to the power tong.

In an embodiment in accordance with the third aspect of the present invention, the method further comprises the step of:
mounting the (selected) mounting adapter, in particular the wrench mounting element of the (selected) mounting adapter, to the backup wrench, in particular to the mounting member of the backup wrench;

In an embodiment in accordance with the third aspect of the present invention, the method comprises the step of:
providing at least one insert, in particular a plurality of inserts; and
mounting the at least one insert to the backup wrench, in particular to the wrench head of the backup wrench.

The step of providing at least one insert may entail providing a first insert and a second insert. In addition, a third, fourth, fifth, etc. insert may be provided.

In an embodiment in accordance with the third aspect of the present invention, the method further comprises the step of:
selecting, in dependency of the size of a non-circular portion of a sucker rod that is to be engaged by the backup wrench, an insert out of the provided inserts that fits best with the non-circular portion of the sucker rod; and
mounting the selected insert to the backup wrench.

In an embodiment in accordance with the third aspect of the present invention, the method further comprises the step of:
connecting the measuring means to a processing unit, in particular to user equipment comprising the processing unit.

In particular, the communication unit of the measuring means is connected to the processing unit. The method may further comprise the step of providing communication means, such as a communication cable.

In an embodiment in accordance with the third aspect of the present invention, the method further comprises the step of:
connecting the processing unit to a control unit; and
connecting the control unit to the torque application system of a power tong.

In an embodiment in accordance with the third aspect of the present invention, the method comprises providing a backup wrench in accordance with any embodiment described in relation to the first aspect.

In an embodiment in accordance with the third aspect of the present invention, the method comprises providing a backup wrench assembly in accordance with any embodiment described in relation to the second aspect.

An advantage of embodiments of the third aspect of the present invention is that a conventional power tong can easily be improved to allow the measuring of torque and/or the controlling of the power tong based on torque measurements.

In accordance with a fourth aspect of the present invention, there is provided the use of a backup wrench assembly. The use comprises the step of:
measuring, by means of measuring means, a torque; wherein the measuring means is provided at a backup wrench. In particular, the step of measuring includes measuring a torque applied by a power tong to a sucker rod, and received at the backup wrench.

In an embodiment in accordance with the fourth aspect, the use further comprises the steps of:
processing, by means of a processing unit, measurement data of the measuring means; and
controlling, by means of a control unit, the torque applied by the power tong based on measurement data processed by the processing unit.

In an embodiment in accordance with the fourth aspect of the present invention, the use comprises the step of:
providing a backup wrench in accordance with any embodiment in accordance with the first aspect.

In an embodiment in accordance with the fourth aspect of the present invention, the use comprises the step of:
providing a backup wrench assembly in accordance with any embodiment in accordance with the second aspect.

It will be clear to the skilled person that the second, third, and fourth, aspect of the present invention may include features relating to the first aspect of any combination of the above described embodiments of the first aspect.

Advantages of the present invention in respect to the first aspect may also be applicable to the second, third, and fourth, aspect of the present invention.

For a better understanding of the present invention, and to show how the same may be put into effect, reference will now be made, by way of example only, to the accompanying drawings in which:

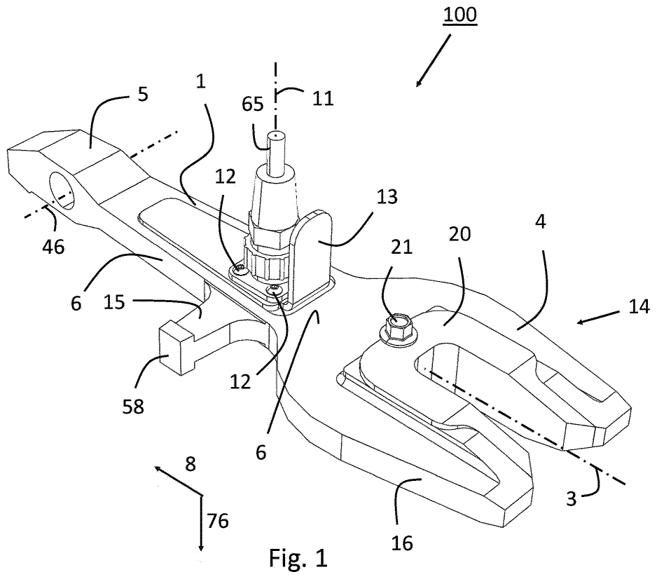

FIG. 1 shows a perspective view of a backup wrench assembly in accordance with the present invention;

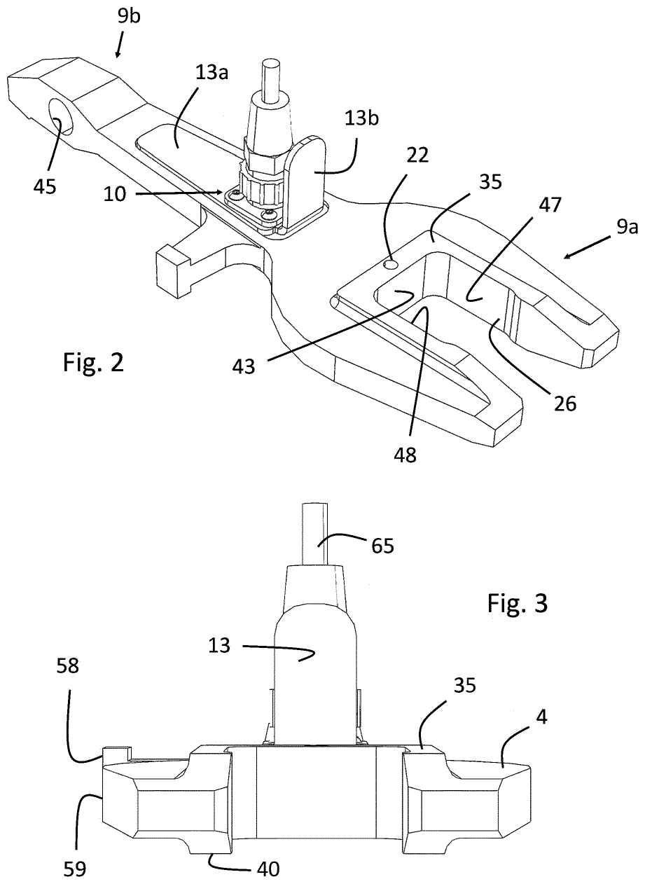

FIG. 2 shows the perspective view of FIG. 1, without an insert;

FIG. 3 shows a front view of the backup wrench shown in FIG. 2;

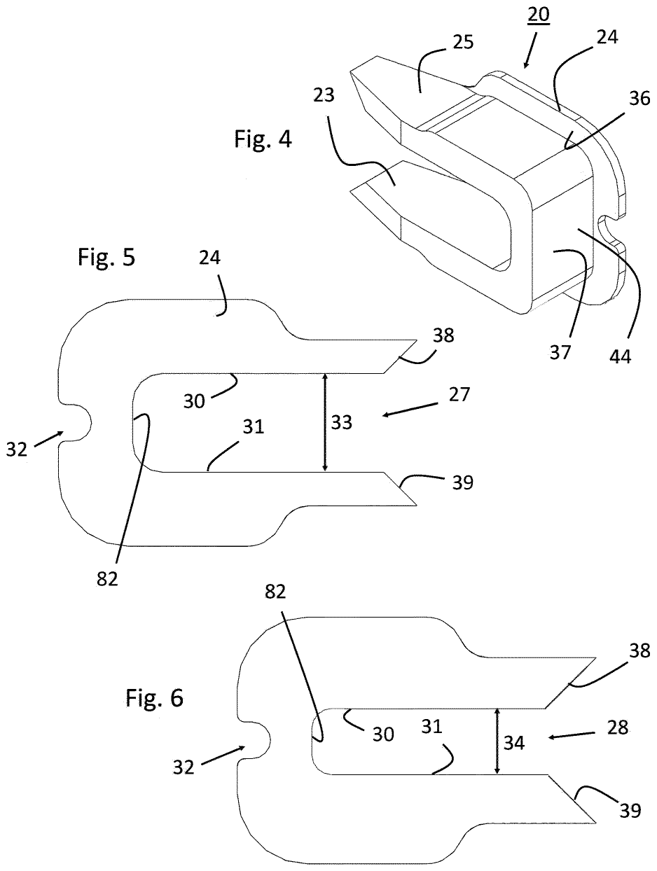

FIG. 4 shows a perspective view of the insert of the backup wrench assembly shown in FIG. 1;

FIG. 5 shows a top view of the insert of FIG. 4;

FIG. 6 shows a top view of an alternative embodiment of an insert that is mountable in the backup wrench shown in FIG. 1;

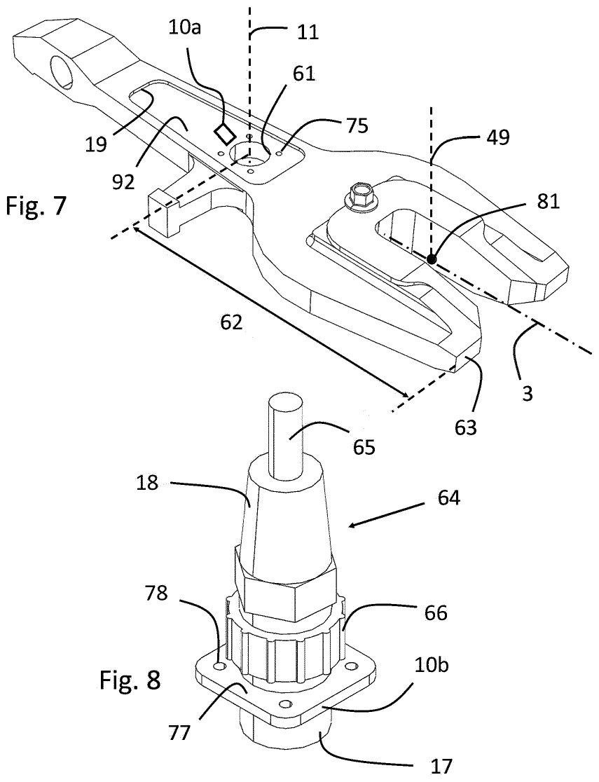

FIG. 7 shows the perspective view of FIG. 1, without part of the measuring means;

FIG. 8 shows a perspective view of a part of the measuring means of the backup wrench shown in FIG. 1;

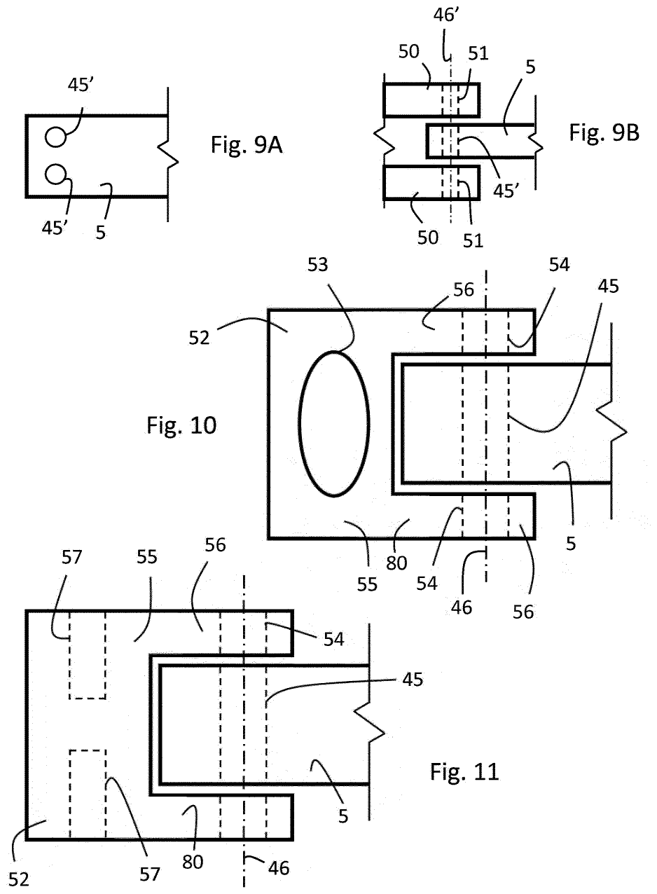

FIG. 9A shows a schematic top view of an alternative embodiment of the mounting member of the backup wrench as shown in FIG. 1;

FIG. 9B shows a schematic side view of the embodiment of the mounting member of FIG. 9A;

FIG. 10 shows a schematic top view of an embodiment of a mounting adapter that is connectable to the mounting member of the backup wrench of FIG. 1;

FIG. 11 shows a schematic top view of an alternative embodiment of a mounting adapter that is connectable to the mounting member of the backup wrench of FIG. 1;

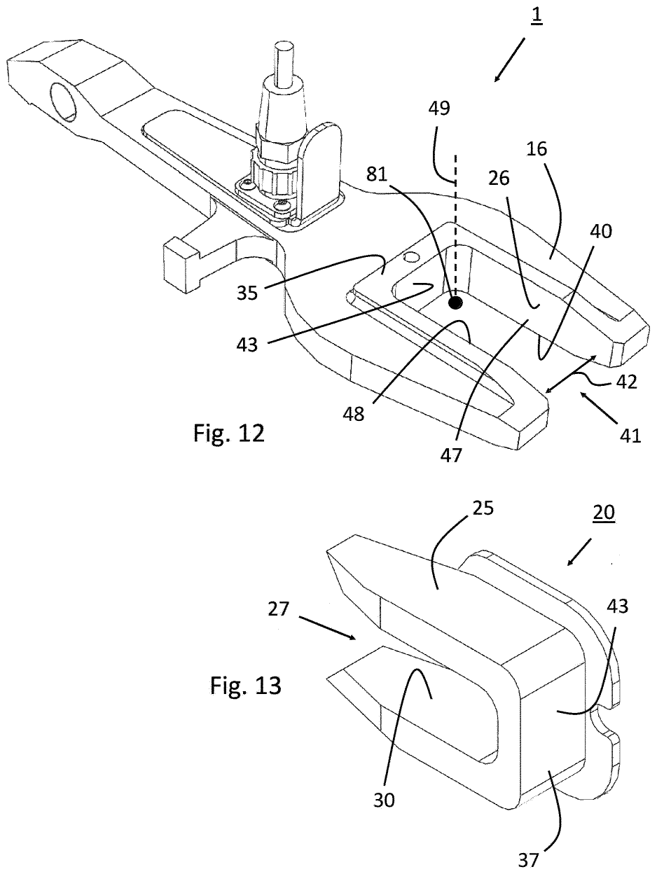

FIG. 12 shows a perspective view of an alternative embodiment of a backup wrench in accordance with the present invention;

FIG. 13 shows a perspective view of an embodiment of an insert for use in the backup wrench of FIG. 12;

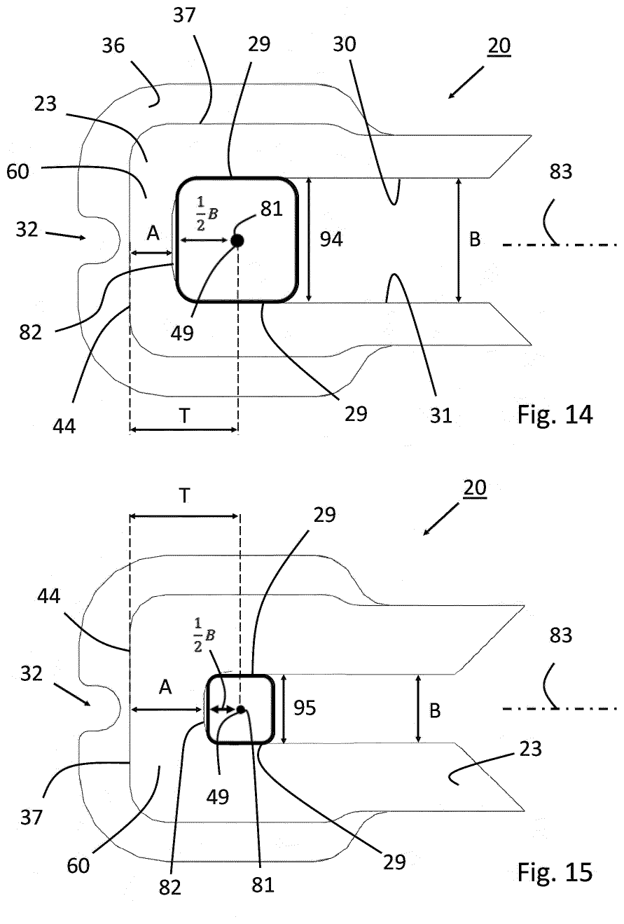

FIG. 14 shows a bottom view of an alternative embodiment of an insert that is mountable in the backup wrench shown in FIG. 1;

FIG. 15 shows a bottom view of another alternative embodiment of an insert that is mountable in the backup wrench shown in FIG. 1; and

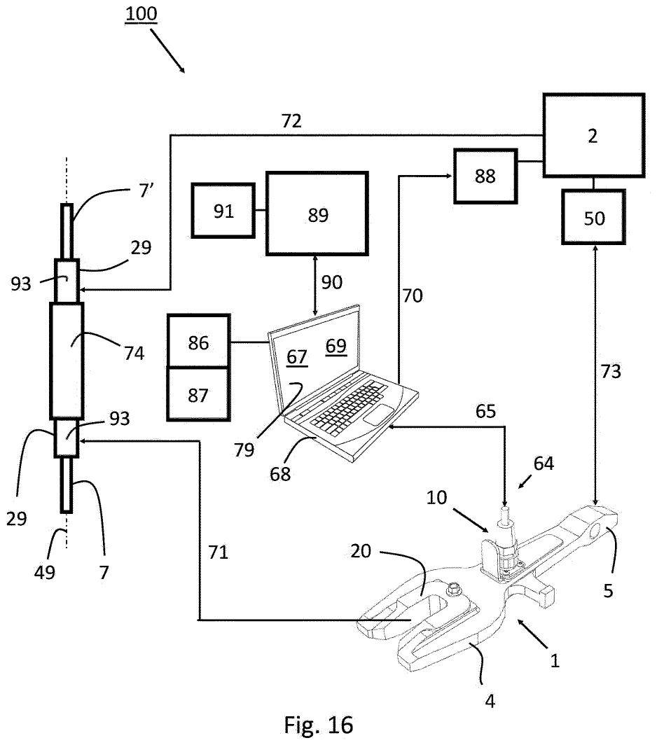

FIG. 16 shows a schematic representation of a backup wrench assembly in accordance with the present invention in combination with a power tong and sucker rods.

FIG. 1 shows a perspective view of a backup wrench assembly 100 comprising a backup wrench 1 that is mountable to a power tong 2. The backup wrench 1 extends longitudinally along a longitudinal axis 3. The backup wrench 1 comprises a wrench head 4, a mounting member 5, and a wrench body 6. The wrench head 4 is provided at a first longitudinal end 9a. The mounting member 5 is provided at a second longitudinal end 9b. The second longitudinal end 9b is, along the longitudinal axis 3, located opposite to the first longitudinal end 9a. The wrench body 6 is located in longitudinal direction 8 along the longitudinal axis 3 between the wrench head 4 and the mounting member 5. The wrench head 4, the mounting member 5, and the wrench body 6 are integrally formed. Hence, the wrench head 4, the mounting member 5, and the wrench body 6 are formed of a single piece of material. The single piece is made of cast iron.

The backup wrench 1 further comprises a measuring means 10. The measuring means 10 is arranged at the wrench body 6. In the embodiment shown in FIG. 1, the measuring means 10 comprises a measuring element 10a, and a communication unit 10b comprising a socket 17 for receiving a plug 18 of a communication means 64, which plug 18 is located at the end of a communication line 65 of the communication means 64. The measuring element 10a is arranged in a slot 19 of the wrench body 6. The communication unit 10b is received in a wrench body hole 61 of the wrench body 6. The wrench body hole 61 is a through hole that is provided in the wrench body slot 19, which through hole extends in a second longitudinal direction 76 along a second longitudinal axis 11. The second longitudinal axis 11 extends perpendicular to the first longitudinal axis 3.

The slot 19 has an upper slot surface 92. In the upper slot surface 92 and around the circumference of the wrench body hole 61, four threaded through holes 75 are provided. The communication unit 10b is mounted to the wrench body 6 by means of bolts 12. To this end, the communication unit 10b comprises a mounting plate 77 with bolt holes 78 for mounting the communication unit 10b to the wrench body 6 by means of the bolts 12. The measuring element 10a is arranged on the upper slot surface 92, and connected via circuit wiring (not shown) to the socket 17.

A protection plate 13 is provided to protect the measuring means 10 and part of the communication means 64. The protection plate 13 comprises a cover part 13a for covering the measuring element 10a, and an extension part 13b for protecting the communication unit 10b and part of the communication means 64 against the collision with objects coming from the wrench head side 14 of the backup wrench 1. The protection plate 13 is mounted to the backup wrench 1 between the wrench body 6 and the communication unit 10b by means of the four bolts 12.

The backup wrench 1 further comprises a stop shoulder 15. The stop shoulder 15 adjoins the wrench body 6. The stop shoulder 15 is integrally formed with the wrench body 6.

The wrench head 4 is adapted to engage a sucker rod 7. To this end, the wrench head 4 comprises a jaw 16. An insert 20 is releasably mounted in the wrench head jaw 16. The wrench head jaw 16 comprises a wrench head jaw top surface 35, a wrench head jaw bottom surface 40, and an internal wrench head jaw profile 26 between the top surface 35 and the bottom surface 40. The top and bottom surface 35, 40 are parallel with respect to each other. The internal wrench head jaw profile 26 comprises two parallel inner wrench head jaw surfaces 47, 48. The insert 20 is kept in place against the internal wrench head jaw profile 26 and the wrench head jaw top surface 35 by means of a bolt 21, which bolt is received in a threaded bolt hole 22 in the wrench head 4.

Features of the insert 20 are shown in more detail in FIGS. 4 to 6. As can be seen in FIG. 4, the insert 20 has an insert jaw 23, and an insert extension part 24. The insert jaw 23 has an external insert jaw profile 25 that corresponds with the internal wrench head jaw profile 26 of the wrench head 4. When the insert 20 is located in the wrench head 4, the entire insert jaw 23 extends within the dimensions of the wrench head 4.

The insert extension part 24 extends away from the external insert jaw profile 25. The insert extension part 24 comprises an insert extension part contact surface 36, which contact surface 36 is perpendicular with respect to an outer surface 37 of the external insert jaw profile 25. The insert extension part contact surface 36 contacts the top surface 35 of the wrench head 4 when the insert 20 is positioned in the wrench head jaw 16.

The insert jaw 23 comprises an insert jaw opening 27, 28 with an insert jaw opening size 33, 34 for receiving the non-circular sucker rod portion 29, in particular the non-circular portion 29 with the wrench flats 93, of a sucker rod 7. The insert jaw opening 27, 28 is bound by inner insert jaw surfaces 30, 31. The surfaces 30, 31 are arranged in parallel with respect to each other, because the wrench flats 93 are also arranged in parallel with respect to each other. That said, it is possible that the wrench flats 93 are inclined with respect to each other, e.g. so as to form the wrench flats 93 of a sucker rod portion 29 having a triangular shaped cross section. In such case, the surfaces 30, 31 are preferably correspondingly angled. The insert jaw 23 further comprises guiding surfaces 38, 39 for guiding a sucker rod 7 towards the insert opening 27, 28.

Depending on the size of the sucker rod portion 32 that is to be engaged with the wrench head 4, a particular insert 20 may be selected. As illustrated by FIGS. 5 and 6, the size of the insert jaw opening 27 is different from that of insert jaw opening 28. In particular, a first distance 33 between inner surfaces 30, 31 of the insert 20 of FIG. 5 is larger than a second distance 34 between the inner surfaces 30, 31 of the insert 20 of FIG. 6. Apart from the difference relating to the distances 33, 34, the inserts 20 are the same. In particular, the inserts 20 have an identical external insert jaw profile 25. This way, each insert 20 can be tightly fitted in the wrench head 4. By providing a plurality of inserts 20 having different insert jaw opening sizes, the backup wrench 1 can be easily adjusted to engage various sucker rods 7.

The extension part 24 of the insert 20 extends away from the external insert jaw profile 25. The extension part 24 limits movement of the insert 20 with respect to the wrench head 4 in a direction 76 transverse to the longitudinal axis 3 of the backup wrench 1, and along the second longitudinal axis 11. In practice, the insert 20 is limited by the extension part 24 in vertical direction, wherein the insert 20 is maintained in the wrench head 4 based on gravity and shape fitting in the internal wrench head jaw profile 26. As such, an operator can, in use, easily insert an insert 20 in the wrench head 4, and subsequently fix the insert 20 to the wrench head 4 by means of a bolt 21. A groove 32 is provided in the extension part 24 to allow the bolt 21 to pass the extension part 24, wherein the bolt 21 can be positioned in part overlapping the extension part 24.

A mounting member 5 is arranged at the second longitudinal end 9b of the backup wrench 1. The second longitudinal end 9b is a free end of the backup wrench 1, wherein the mounting member 5 is configured for releasably mounting the backup wrench 1 to a power tong 2. In the embodiment shown in FIG. 1, the mounting member 5 comprises a through hole 45. The through hole 45 extends along a through hole axis 46, which through hole axis 46 is perpendicular with respect to the inner wrench head jaw surfaces 47, 48. In particular, the hole axis 46 is perpendicular to the inner insert jaw surfaces 30, 31 of the insert 20.

That being said, alternative mounting members 5 are envisioned. FIG. 9A shows a schematic top view, and FIG. 9B shows a schematic side view, of an alternative mounting member 5 of a backup wrench 1. Here, the mounting member 5 comprises two through holes 45′. Different from the through hole 45 of the embodiment shown in FIG. 1, the through holes 45′ of the mounting member 5 of FIGS. 9A and 9B have a through hole axis 46′ that extends parallel to inner wrench head jaw surfaces 47, 48, wherein in practice the through hole axes 46′ extend vertically. The mounting member 5 of FIGS. 9A and 9B can be mounted to a backup wrench mount 50 of a power tong 2 by aligning the through holes 51 of the backup wrench mount 50 with the through holes 45′ of the mounting member 5 of the backup wrench 1, and connecting the parts by means of a bolt (not shown). Hence, it is clear that the backup wrench 1 in accordance with the present invention may have different mounting members 5. In addition, one can envision a mounting member 5 with boltholes 45, 45′ extending parallel to the longitudinal axis 3 of the backup wrench 1. The mounting member 5 can be adapted without influencing the configuration of the measuring means 10.

In other embodiments of the present invention, a mounting adapter 52 may be provided. The adapter 52 forms an intermediate connection piece connecting the mounting member 5 with the power tong 2. A schematic representation of mounting adapter embodiments is shown in FIGS. 10 and 11. In the shown embodiments, the mounting member 5 is similar to the mounting member 5 as shown in, and described in relation to, FIG. 1. The mounting member 5 again comprises a through hole 45. The adapter 52 comprises a power tong mount 55 for mounting the mounting adapter 52 to the backup wrench mount 50 of a power tong 2, and a wrench mounting element 80 comprising two legs 56 extending from the power tong mount 55. The legs 56 comprise through holes 54, wherein the adapter 52 can be mounted to the backup wrench 1 by aligning the through holes 54 with the through hole 45 of the backup wrench 1 and by providing a bolt or pin in the through holes. The power tong mount 55 comprises a mounting element 53 for mounting the adapter 52 to a corresponding element (not shown) of the backup wrench mount 50 of the power tong 2. In FIG. 10, the mounting element 53 has an oval shaped opening for receiving a corresponding insertion part of the backup wrench mount 50. Nevertheless, alternative ways of mounting the adapter 52 to the power tong mount 50 are foreseen. In this regard, FIG. 11 shows an adapter 52 with threaded holes 57.

To keep the backup wrench 1 from pivoting about the through hole axis 46, it is possible to provide additional through holes 46. Alternatively or additionally, the mounting member 5, and/or adapter 52 may comprise a protrusion (not shown) to restrict pivoting of the backup wrench 1 with respect to the power tong 2.

Preferably, the assembly 100 comprises a plurality of mounting adapters 52, wherein each of the plurality of adapters 52 has a different power tong mount 55, and wherein each power tong mount 55 is configured to fit with the backup wrench mount 50 of a power tong 2 of a set of power tongs that are regularly used at hydrocarbon wells. By providing such assembly 100 with interchangeable adapters 52, wherein each adapter has an individual power tong mount 55 that is configured to fit with a particular backup wrench mount of power tong of a set of regularly used power tongs, an operator may be equipped with suitable mounting equipment out of which the operator can readily select a suitable mounting adapter on the spot, even when only little is known about the particular power tong at the hydrocarbon well.

Turning back to the embodiment as shown in FIG. 1. A stop shoulder 15 is arranged adjacent the wrench body 6. In particular, the stop shoulder 15 is, when seen along the longitudinal axis 3, arranged at an axial stop shoulder distance 62 from the terminal (or free) end surface 63 of the wrench head 4. The stop shoulder 15 has a stop shoulder surface 58. As can be seen in FIG. 3, the stop shoulder surface 58 is flush to an outer lateral side 59 of the backup wrench 1. As such, the stop shoulder 15 is within the exterior boundaries of the backup wrench 1 in a direction perpendicular to longitudinal axes 3, 11. Accordingly, hindrance by the stop shoulder 15 when installing the wrench 1 in a power tong 2 may be limited. In practice, the stop shoulder 15 provides a stop for limiting the backup wrench 1 when the backup wrench 1 is exposed to torque. In general, the stop shoulder stops against a part of power tong 2.

The measuring means 10 of the backup wrench 1 is arranged at the wrench body 6. The measuring means 10 comprises a measuring element 10a including a strain gauge. In the preferred embodiment, the strain gauge is arranged next to the wrench body hole 61, the center of which is located at the axial stop shoulder distance 62 from the free end surface 63 of the wrench head 4. Hence, the axial stop shoulder distance 62 is (about) the same as a measuring element distance between the measuring element 10a and the free end surface 63 of the wrench head 4. Alternatively, it is envisioned that the measuring element 10a is located between the insert 20 and the wrench head 4. This would, however, have the disadvantage of interfering with the measuring means when replacing the insert 20.

FIGS. 12 and 13 show perspective views of an alternative embodiment of a backup wrench, and a corresponding insert, respectively. The backup wrench 1 is similar to the backup wrench 1 of FIG. 1, albeit that the wrench head 4 comprises a wrench head jaw 16 with an internal wrench head jaw profile 26, wherein the wrench head 4 is adapted to engage a sucker rod directly, without the need for an insert 20. To this end, the internal wrench head jaw profile 26 comprises two wrench head jaw surfaces 47, 48 that a located at a distance from each other, wherein the wrench head jaw surfaces 47, 48 define a wrench head jaw opening 41 for receiving a sucker rod 7. The wrench head jaw surfaces 47, 48 define an opening size 42, which size corresponds to the size 94, 95 of a non-circular portion of a sucker rod 7.

The insert 20 of FIG. 13 is of similar construction as the inserts shown in FIGS. 4, 5, and 6, albeit that the external insert jaw profile 25 is configured to fit with the internal wrench head jaw profile 26 of the backup wrench 1 of FIG. 12. It should be appreciated that the insert 20 comprises an insert jaw opening 27 that is smaller than the wrench head jaw opening 41.

The wrench head 4 defines a rotation axis position 81. The rotation axis position 81 is a position along the longitudinal axis 3 at which the central rotation axis 49 of a sucker rod 7 is positioned when engaged by the backup wrench 1. When the sucker rod 7 is engaged by the wrench head 4, the power tong 2 may transfer torque along the central rotation axis 49.

In certain embodiments of the present invention, the inserts 20 are dimensioned to engage a sucker rod 7 of a particular size, wherein the central rotation axis 49 of the respective sucker rod 7 is located at the rotation axis position 81.

The wrench head 4, in particular the wrench head jaw 16, more in particular the internal wrench head jaw profile 26, comprises an axial contact surface 43 for contacting a positioning part surface 44 of an insert 20. When mounted in the wrench head 4, the insert 20 is positioned against the axial contact surface 43.

As can be seen in FIGS. 14 and 15, the inserts 20 may have an insert jaw 23 comprising a positioning part 60. The positioning part 60 is designed to position the central rotation axis 49 of an engaged sucker rod 7 at the rotation axis position 81 of the wrench head 1. The positioning part 60 comprises a positioning part surface 44, and a sucker rod positioning part surface 82. The positioning part 60 has a thickness A. The thickness A is measured in a longitudinal direction along a longitudinal insert axis 83 between the surfaces 44 and 82.

The longitudinal extent A of the positioning part 60 may be determined based on a given insert jaw opening size 33, 34, B, and on a given distance T, wherein distance T is the longitudinal distance between the positioning part surface 44 and the rotation axis position 81. Hence, distance T may be determined with respect to a wrench head 4. In inserts 20 employing a positioning part 60, the distance T will be the same for each insert 20.

As can be seen in FIG. 14 as compared to FIG. 15, the insert 20 of FIG. 15 has a smaller opening size 33, 34, B than the insert of FIG. 14. The distance T is the same for both inserts 20. The insert 20 of FIG. 15 has a positioning part 60 that has a greater thickness A than the positioning part 60 of the insert 20 of FIG. 14. Accordingly, it can be made sure that the central rotation axis 49 of a sucker rod 7 engaged by the insert 20 of FIG. 14 is positioned at a distance T from the axial contact surface 43 of the wrench head 4, and that the central rotation axis 49 of a sucker rod 7 engaged by the insert 20 of FIG. 15 is positioned at the distance T from the axial contact surface 43 of the wrench head 4. This way, a fixed distance between a sucker rod 7 engaged by the wrench head 4 and the measuring element 10a can be maintained for various sucker rod sizes.

The opening size 33, 34, B, of the insert 20 of FIG. 14 is the same as the size 94 of the non-circular portion 29 of the sucker rod 7 provided in the insert 20 of FIG. 14. The opening size 33, 34, B, of the insert 20 of FIG. 15 is the same as the size 95 of the non-circular portion 29 of the sucker rod 7 provided in the insert 20 of FIG. 15. The size 94, 95 of the non-circular portion 29 may be measured in a cross sectional plane with respect to the central longitudinal axis 49 of the sucker rod 7.

FIG. 16 shows a schematic representation of an embodiment of a backup wrench assembly 100 in accordance with the present invention, which comprises a backup wrench 1 and an insert 20 as shown in FIG. 1. FIG. 16 further shows a power tong 2, two sucker rods 7, 7′, and a coupling 74.

The power tong 2 holds 72 an upper sucker rod 7′ of the two sucker rod 7, 7′ at its wrench flats 93 by means of rotatable power tong jaws (not shown). The backup wrench 1 is mounted on the power tong 2 at the mounting member 5 via a mechanical connection 73 as described above. The wrench head 4 with the insert 20 holds 71 a lower sucker rod 7 of the two sucker rods 7, 7′ in place, wherein rotational movement of the lower sucker rod 7 about the rotation axis 81 is limited by the backup wrench 1. In many cases, the lower sucker rod 7 and the coupling 74 are already connected to a string of sucker rods during the make-up process.

The backup wrench assembly 100 further comprises a communication means 64 that is communicatively connected, on the one hand, to the measuring element 10a via the communication unit 10b of the measuring means 10, and, on the other hand, to a processing unit 67. The communication means 64 comprises a communication line 65, in particular a cable, that ends in a plug 18. The plug 18 fits into the socket 17 of the communication unit 10b. The communication means 64 further comprises a rotatable fixing unit 66 for rotatably fixing the plug 18 in the socket 17. To this end, the communication unit 10b comprises a thread (not shown). The communication line 65 is configured for transferring an electrical signal. In particular, an electrical input signal is transferred via the communication line 65 to the measuring element 10a, and an electrical output signal is transferred via the communication line 65 from the measuring element 10a to the processing unit 67.

The processing unit 67 is comprised by user equipment 68 in the form of a laptop. Alternatively, user equipment 68 may be a tablet, a desktop, a smartphone, portable torque reader, etc.

The processing unit 67 is configured for processing measurement data, in particular an electrical output signal, from the measuring means 10. In particular, the measuring element 10a is connected to an electrical input and an electrical output, wherein a torque indicator such as a material deformation causes a change in electrical resistance at the measuring element 10a. The processing unit 67 is arranged to process the measurement data of the measuring element 10a, wherein the electrical input signal, which may relate to an electric pressure, is compared to the electrical output signal, which may also relate to an electric pressure. The difference between input and output is then, based on an algorithm, translated to an amount of torque. For determining the amount of torque, the distance between the measuring element 10a and the rotation axis position 81 is taken into account. Preferably, measurements are time stamped, wherein the time stamped measurement data is stored in a storage unit 86. The storage unit 86 is provided at the user equipment 68.

In certain embodiments, the processing unit processing unit 67 is configured to compare the processed measurement data with threshold torque values. In particular, the processing unit 67 is configured for comparing the determined torque value with a lower bound and an upper bound of a threshold torque value range. If the lower or upper bound of the threshold torque value range is surpassed, the processing unit 67 may provide a signal.

The processing unit 67 may further be connected to a database 87. The database 87 is comprised by the user equipment 68. The database 87 comprises specific sucker rod information, such as a minimum and maximum threshold torque value required for making up specific sucker rods, sucker rod outer diameter, and the above mentioned correction factor x.

The assembly 100 further comprises a control unit 69. The control unit 69 is provided at the user equipment 69. The control unit 69 is communicatively connected by means of a communication line 70 to a torque application system 88 of the power tong 2, wherein the control unit 69 is configured to control the torque applied by the power tong 2.

The user equipment 68 comprises an interface (e.g. screen) 79 for presenting to an operator an amount of torque received at the backup wrench 1.

The backup wrench assembly 100 further comprises a user system 89. The user system 89 is arranged at a distance from the user equipment 68, wherein the user equipment 68 and the user system 89 are connected with each other via a wireless communication line 90. The user equipment 68 and the user system 89 communicate with each other via a cellular network. Preferably, the user system 89 comprises a second processing unit 91, wherein the second processing unit is configured for receiving time stamped torque measurement data from the user equipment 68, and for plotting the time stamped torque data on a screen at the user system 89. The user system 89 may comprise the database 87.

In use, the power tong 2 applies a torque to the upper sucker rod 7′, which torque causes the upper sucker rod 7′ to rotate with respect to the coupling 74 and the lower sucker rod 7. As the make-up process proceeds, torque applied by the power tong 2 is transferred via the coupling 74 and the lower sucker rod 7 to the backup wrench 1. The measuring means 10 measure the torque received at the backup wrench 1, wherein the measurements are communicated via the communication cable 65 to the user equipment 68. Here, the processing unit 67 of the user equipment 68 processes the measurement data, wherein the measurement data is translated into a certain amount of torque. The torque measurements are presented via the laptop screen 79 to the power tong operator. As the torque received at the backup wrench 1 increases to above the upper threshold value, the control unit 69 instructs the torque application system 88 of the power tong 2 to reduce the amount of torque applied by the jaws of the power tong 2. When an amount of torque has been applied that corresponds with the specifications of the particular sucker rods 7, 7′, the connection between the sucker rods has been made up, and the make-up process may be terminated.

As required, detailed embodiments of the present invention have been disclosed in the figures. However, it is to be understood that the disclosed embodiments are merely exemplary, wherein invention can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The terms “a” or “an”, as used herein, are defined as one or more than one. The terms multitude or plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

It will be apparent to those skilled in the art that various modifications can be made to the shown backup wrench and backup wrench assembly according to the invention without departing from the scope as defined in the claims.

1. A backup wrench for a power tong, the backup wrench comprising a measuring means for measuring torque.

2. The backup wrench of claim 1, further comprising a mounting member for mounting the backup wrench to a backup wrench mount of a power tong, wherein the measuring means is located away from the mounting member.

3. The backup wrench of claim 1, further comprising a wrench head for engaging a sucker rod, wherein the measuring means is located away from the wrench head.

4. The backup wrench of claim 1, wherein the backup wrench comprises a wrench body, and the measuring means comprises a measuring element, wherein the measuring element is provided at the wrench body.

5. The backup wrench of claim 4, wherein the wrench body comprises a wrench body slot, wherein the measuring element is arranged in the wrench body slot.

6. The backup wrench of claim 4, wherein the backup wrench comprises a stop shoulder, and the measuring element is located next to the stop shoulder.

7. (canceled)

8. The backup wrench of claim 1, the measuring means further comprising a communication unit.

9. The backup wrench of claim 8, wherein the communication unit is configured for a wired connection.

10. The backup wrench of claim 1, wherein the measuring means comprises a strain gauge.

11. A backup wrench assembly for use with a power tong and comprising a backup wrench including measuring means for measuring torque.

12. The backup wrench assembly of claim 11, wherein the backup wrench comprises a wrench head and wherein the backup wrench assembly further comprises:
a first insert, the first insert being mountable to the wrench head and adapted for engaging a first non-circular portion of a first sucker rod having a first size.

13. The backup wrench assembly of claim 11, wherein the backup wrench comprises a mounting member, the backup wrench assembly further comprising:
at least one mounting adapter, the at least one mounting adapter being mountable to the mounting member and having a power tong mount for mounting the at least one mounting adapter to a backup wrench mount of the power tong, wherein the mounting member is different from the power tong mount.

14. The backup wrench assembly of claim 11, wherein the backup wrench comprises a wrench body and wherein the measuring means is located at the wrench body.

15. The backup wrench assembly of claim 23, wherein:
the wrench head defines a rotation axis position;
the first insert is dimensioned to receive the first sucker rod such that a first rotation axis of the first sucker rod is at the rotation axis position; and
the second insert is dimensioned to receive the second sucker rod such that a second rotation axis of the second sucker rod is at the rotation axis position.

16. The backup wrench assembly of claim 23, wherein each of the first and second inserts comprises:
an insert opening having an insert opening size for receiving a corresponding one of the first and second sucker rods, and
a positioning part for positioning the corresponding one of the first and second sucker rods received in the insert opening, wherein each insert complies with:
$$A = T - \frac{1}{2} B ,$$
wherein A is a longitudinal extent of the positioning part, B is an insert opening size, and T is a longitudinal distance from and including the positioning part up to a rotation axis position of the wrench head.

17. The backup wrench assembly of claim 11, further comprising:
a processing unit for processing measurement data of the measuring means; and
a communication means, wherein the communication means is suitable for communicatively connecting the measuring means to the processing unit.

18. A method of assembling a backup wrench assembly to a power tong, the method comprising:
mounting a backup wrench to the power tong, wherein the backup wrench comprises a measuring means for measuring torque.

19. The method of claim 18, further comprising:
connecting the measuring means to a processing unit;
connecting the processing unit to a control unit; and
connecting the control unit to a torque application system of the power tong.

20. (canceled)

21. A method of using the backup wrench assembly of claim 11, the method comprising:
measuring a torque applied to a sucker rod by the power tong using the measuring means.

22. The method of claim 21, wherein measuring the torque applied to the sucker rod by the power tong using the measuring means comprises generating measurement data with the measuring means and wherein the backup wrench assembly comprises a processing unit and a control unit, the method further comprising:
processing the measurement data from the measuring means using the processing unit; and
controlling the torque applied to the sucker rod by the power tong using the control unit and based on the processed measurement data.

23. The backup wrench assembly of claim 12, further comprising:
a second insert, the second insert being mountable to the wrench head and adapted for engaging a second non-circular portion of a second sucker rod having a second size.

24. The backup wrench assembly of claim 12, wherein the wrench head is adapted for engaging a second non-circular portion of a second sucker rod having a second size.
